(19) United States
(12) Patent Application Publication
(10) Pub. No.: US 2025/0040734 A1
(43) Pub. Date: Feb. 6, 2025

(54) Portable Gardening Structure Device

(71) Applicant: Richard Shepard, Tavares, FL (US)

(72) Inventor: Richard Shepard, Tavares, FL (US)

(21) Appl. No.: 18/738,617

(22) Filed: Jun. 10, 2024

Related U.S. Application Data
(60) Provisional application No. 63/516,922, filed on Aug. 1, 2023.

(51) Int. Cl. A47G 7/04; A01G 9/02

(52) U.S. Cl. CPC A47G 7/04; A01G 9/022

(57) ABSTRACT

A portable gardening structure device is provided. The device is comprised of a frame that may be comprised of at least one vertical frame member or a plurality of vertical frame members and at least one horizontal frame member. A plurality of pots, in which plants may be planted, may be attached to the frame via at least one fastener. The frame may be driven into a ground surface, providing decoration in a garden bed or other exterior area, or attached to a wall surface, providing decoration to the interior of a home.

### CROSS-REFERENCE TO RELATED APPLICATION

The present application claims priority to, and the benefit of, U.S. Provisional Application No. 63/516,922, which was filed on Aug. 1, 2023, and is incorporated herein by reference in its entirety.

### FIELD OF THE INVENTION

The present invention relates generally to the field of gardening. More specifically, the present invention relates to a portable gardening structure device that has at least one gardening pot on at least one frame that may be driven into a ground surface, providing decoration in a garden bed or other exterior area, or attached to a wall surface, providing decoration to the interior of a home. Accordingly, the present disclosure makes specific reference thereto. Nonetheless, it is to be appreciated that aspects of the present invention are also equally applicable to other like applications, devices, and methods of manufacture.

### BACKGROUND

Different ways to decorate a home and its surrounding yard are constantly evolving to include new and unique methods of decorating with both old and new decorations. Often, plants of many kinds are used to decorate both the interior and exterior of homes. However, many homeowners and renters alike typically only plant plants in the ground or a pot to be set on a table or countertop.

Therefore, there exists a long-felt need in the art for a device that can arrange plants in a decorative manner. More specifically, there exists a long-felt need in the art for a portable gardening structure device that can be used to decorate both the interior and exterior of a house with plants. Furthermore, there exists a long-felt need in the art for a portable gardening structure device that can arrange plants vertically, providing height and depth to a garden bed, wall, or other structure.

The subject matter disclosed and claimed herein, in one embodiment thereof, comprises a portable gardening structure device. The device is comprised of a frame that may be comprised of at least one vertical frame member or a plurality of vertical frame members and at least one horizontal frame member. A plurality of pots, in which plants may be planted, may be attached to the frame via at least one fastener. The frame may be driven into a ground surface, providing decoration in a garden bed or other exterior area. The frame may also be attached to a wall surface, providing decoration to the interior of a home.

In this manner, the portable gardening structure device of the present invention accomplishes all the foregoing objectives and provides a device that can arrange plants and other greenery in a decorative manner. More specifically, the portable gardening structure device can decorate the interior space, such as a wall, of a home as well as the exterior space of a home, such as a garden bed. Furthermore, the portable gardening structure device can arrange plants vertically, providing a change to the typically horizontally arranged plants around a home or garden.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a portable gardening structure device comprised of a frame and at least one pot. The device is designed to display plants in a vertical orientation along a frame to decorate any part of the interior or exterior of a home.

The device is comprised of a frame that is preferably made from a wood or metal material. The frame is further comprised of at least one vertical frame member that is further comprised of a fastener that allows the vertical frame member to easily penetrate a ground surface. At least one pot may be comprised of at least one fastener that allows the pot to fixedly or removably attach to the vertical frame member. In this embodiment, a plurality of pots may be aligned vertically along the vertical frame member.

In one potential embodiment, the frame may be further comprised of at least one horizontal frame member that may connect a plurality of vertical frame members. At least one pot may still be attached to the vertical frame members via at least one fastener. In addition, the vertical frame members of the frame may be attached to a wall surface, providing decoration on the interior of a home. The frame may also be comprised of a decorative element. The decorative element may be any image, video, text, character, object, color, texture, etc., that is preferred by the user.

The present invention is also comprised of a method of using the device. First, a device is provided comprised primarily of a frame and at least one pot. Then, at least one pot may be fixedly or removably attached to the vertical frame member via at least one fastener. Then, drive the vertical frame member into the ground surface. Next, the user may plant any type of plant into each pot that is attached to the vertical frame member.

The present invention is also comprised of a second method of using the device. First, a device is provided comprised primarily of a frame and at least one pot. Then, a plurality of vertical frame members may be connected by attaching at least one horizontal frame member to each vertical frame member of the frame. Then, the frame may be secured to the wall surface via at least one fastener of the vertical frame member. Next, at least one pot may be fixedly or removably attached to the vertical frame members or the horizontal frame members of the frame via at least one fastener. Then, the user may plant any type of plant into each pot that is attached to the vertical frame member.

Accordingly, the portable gardening structure device of the present invention is particularly advantageous as it provides a device that can arrange plants and other greenery in a decorative manner. More specifically, the portable gardening structure device can arrange plants vertically, providing a change to the typically horizontally arranged plants around a home or garden. Furthermore, the portable gardening structure device can decorate the interior space, such as a wall, of a home as well as the exterior space of a home, such as a garden bed, with any plant desired by the user. In this manner, the portable gardening structure device overcomes the limitations of existing devices and methods of gardening known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a portable gardening structure device of the present invention while on a ground surface in accordance with the disclosed architecture;

FIG. 2 illustrates a perspective view of one potential embodiment of a portable gardening structure device of the present invention while attached to a wall in accordance with the disclosed architecture;

FIG. 3 illustrates a side view of one potential embodiment of a portable gardening structure device of the present invention while attached to a wall in accordance with the disclosed architecture;

FIG. 4 illustrates a flowchart of a method of using one potential embodiment of a portable gardening structure device of the present invention in accordance with the disclosed architecture; and

FIG. 5 illustrates a flowchart of a method of using one potential embodiment of a portable gardening structure device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that can arrange plants in a decorative manner. More specifically, there exists a long-felt need in the art for a portable gardening structure device that can be used to decorate both the interior and exterior of a house with plants. Furthermore, there exists a long-felt need in the art for a portable gardening structure device that can arrange plants vertically, providing height and depth to a garden bed, wall, or other structure.

The present invention, in one exemplary embodiment, is comprised of a portable gardening structure device. The device is primarily comprised of a frame and at least one pot. The device is designed to display plants in a vertical orientation along a frame to decorate any part of the interior or exterior of a home.

More specifically, the device is comprised of a frame that is preferably made from a wood or metal material. The frame is further comprised of at least one vertical frame member. One end of the vertical frame member may be pointed such as to easily penetrate a ground surface. Preferably, the other end of the vertical frame member may be flat, providing more surface area from which the vertical frame member may be pushed into the ground. The vertical frame member may be further comprised of a fastener that may accept at least one pot. In differing embodiments, the pot may be comprised of a fastener that attaches to the vertical frame member or both the pot and the vertical frame member may be comprised of fasteners that allow the pot to attach to the vertical frame member. The pot may further be fixedly or removably attached to the vertical frame member.

In one potential embodiment, the frame may be further comprised of at least one horizontal frame member that may connect at least two vertical frame members. In this embodiment, a rear surface of the horizontal frame member may be comprised of a fastener that fixedly or removably attaches the horizontal frame member to a top surface of at least one vertical frame member. Further, the top surface of the vertical frame member may be comprised of a fastener to aid in the attachment between the vertical frame member and the horizontal frame member or to attach a pot to the vertical frame member.

Both the vertical frame member and the horizontal frame member of the frame, in any embodiment of the device, may be further comprised of a decorative element. The decorative element may be any image, video, character, text, object, etc., that is preferred by the user. The decorative element may be attached to the frame by any method known in the art, such as by a fastener or a coating method such as paint. In one potential embodiment, the device may be attached to a wall surface of a home. The wall surface may be any interior or exterior wall surface of the home. In this embodiment, the vertical frame member may be further comprised of at least one fastener that allows the device to fixedly or removably attach to the wall surface.

The present invention is also comprised of a method of using the device. First, a device is provided comprised primarily of a frame and at least one pot. Then, at least one pot may be fixedly or removably attached to the vertical frame member via at least one fastener. Then, drive the vertical frame member into the ground surface. Next, the user may plant any type of plant into each pot that is attached to the vertical frame member.

The present invention is also comprised of a second method of using the device. First, a device is provided comprised primarily of a frame and at least one pot. Then, a plurality of vertical frame members may be connected by attaching at least one horizontal frame member to each vertical frame member of the frame. Then, the frame may be secured to the wall surface via at least one fastener of the vertical frame member. Next, at least one pot may be fixedly or removably attached to the vertical frame members or the horizontal frame members of the frame via at least one fastener. Then, the user may plant any type of plant into each pot that is attached to the vertical frame member.

Accordingly, the portable gardening structure device of the present invention is particularly advantageous as it provides a device that can arrange plants and other greenery in a decorative manner. More specifically, the portable gardening structure device can decorate the walls or gardens of both interior and exterior spaces of a home. Furthermore, the portable gardening structure device can take plants that are typically arranged horizontally and align them vertically, providing individuality and uniqueness to the greenery decorations of a home. In this manner, the portable gardening structure device overcomes the limitations of existing devices and methods of gardening known in the art.

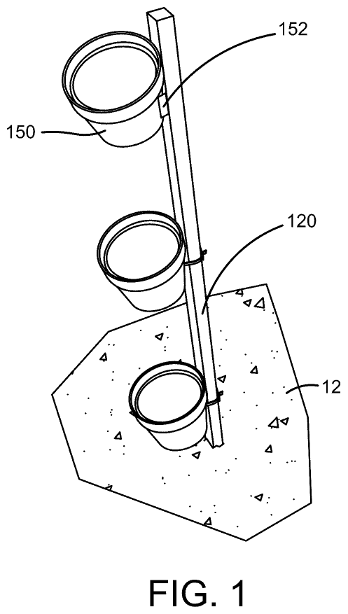

Referring initially to the drawings, FIG. 1 illustrates a perspective view of one potential embodiment of a portable gardening structure device 100 of the present invention within a ground surface 12 in accordance with the disclosed architecture. The device 100 is primarily comprised of a frame 110 and at least one pot 150 attached to the frame 110. The device 100 is designed to display plants in a vertical orientation (or in another embodiment, horizontal orientation) along a frame 110 to decorate any part of the interior or exterior of a home.

The frame 110 may be made from any material, such as metal or plastic, but is preferably made from wood. The frame 110 is further comprised of at least one vertical frame member 120. The vertical frame member 120 may be pushed into a ground surface 12 to secure the device 100 into the ground surface 12. Preferably, one end of the vertical frame member 120 may be pointed to allow the member 120 to be easily pushed into the ground surface 12 and remain stable. Further, the other end of the vertical frame member 120 may remain flat, providing an area from which a user may push the vertical frame member 120 into the ground surface 12.

At least one pot 150 may be fixedly or removably attached to the vertical frame member 120. In one embodiment, the pot 150 is attached via at least one fastener 152. The fastener 152 of the pot 150 may be any fastener such as, but not limited to, a screw, a nail, an adhesive, glue, hook-and-loop fastener, tongue-and-groove fastener, magnet, etc., but is preferably a tie wrap.

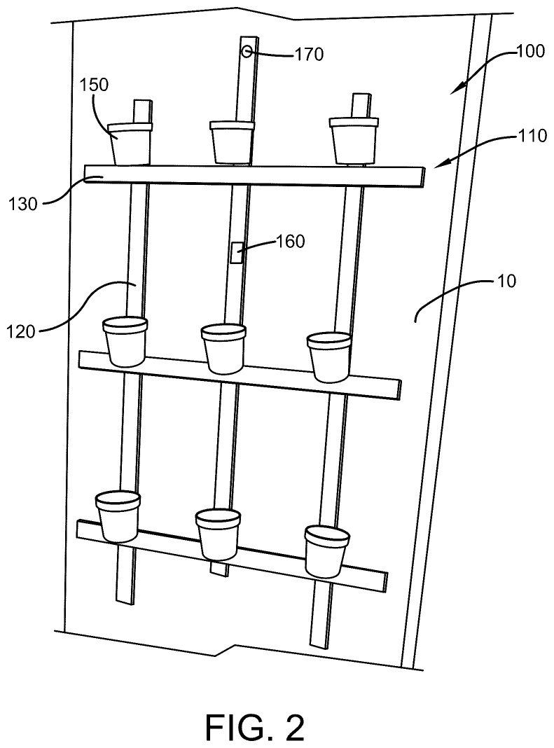

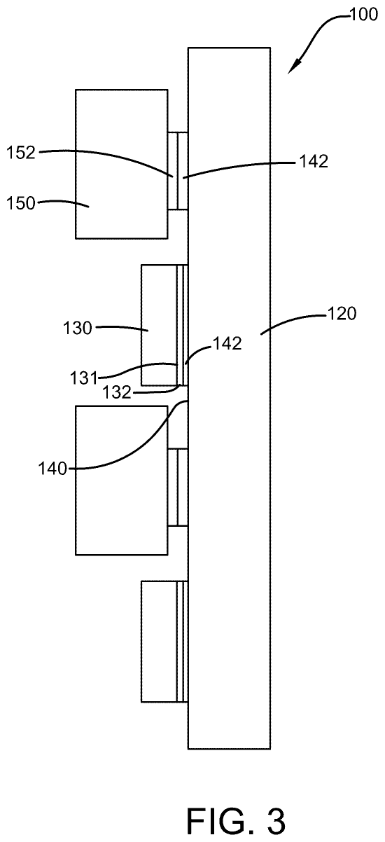

In one potential embodiment, the device 100 may be comprised of a frame 110 that is further comprised of a plurality of vertical frame members 120 connected by at least one horizontal frame member 130, as seen in FIG. 2 and FIG. 3. In this embodiment, a rear surface 131 of the horizontal frame member 130 may be comprised of at least one fastener 132 that may fixedly or removably attach the horizontal frame member 130 to each vertical frame member 120. Further, a top surface 140 of the vertical frame member 120 may be comprised of at least one fastener 142. The fasteners 132, 142 may be any type known in the art such as, but not limited to, a magnet, a glue, a tongue, a groove, a hook fastener, a loop fastener, a screw, a bolt, etc.

In differing embodiments, the fastener 132 of the horizontal frame member and the fastener 142 of the vertical frame member 120 may secure the horizontal frame member 130 and the vertical frame member 120 together individually or be used together to provide additional support and stability for the frame 110 of the device 100, as best seen in FIG. 3. Further, the fastener 142 of the top surface 140 of the vertical frame member 120 may also provide support from which the pot 150 may attach to the vertical frame member 120.

The frame 110 may be attached to a wall surface 10 via at least one fastener 170 such that the device 100 can be hung indoors. The fastener 170 is preferably a screw but may be any fastener known in the art that is commonly used to fixedly or removably attach an object to a wall surface 10. The device 100 may attach to any wall surface 10 on the interior or exterior of a home. In addition, any embodiment of the device 100 may be further comprised of a decorative element 160. The decorative element 160 may be any image, video, character, text, color, object, paint, texture, etc., that is preferred by the user. The decorative element may further be used to provide additional protection to the device 100, such as a protective coating for weather protection.

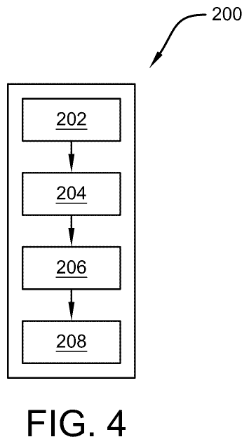

The present invention is also comprised of a method 200 of using the device 100, as seen in FIG. 4. First, a device 100 is provided comprised of a frame 110 comprised of at least one pot 150 attached to the frame 110 [Step 202]. Then, the pot 150 may be fixedly or removably attached to the vertical frame member 120 via at least one fastener 152 [Step 204]. Next, a user can drive the vertical frame member 120 into the ground surface 12 [Step 206]. Then, the user may plant any type of plant into each pot 150 that is attached to the vertical frame member 120 [Step 208].

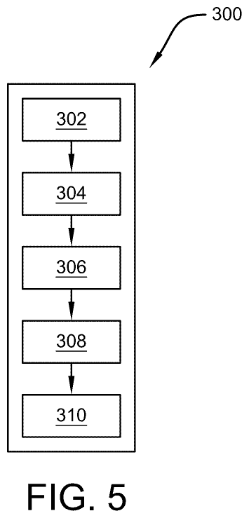

The present invention is also comprised of a second method 300 of using the device 100, as seen in FIG. 5. First, a device 100 is provided comprised of a frame 110 and at least one pot 150 attached to the frame 110 [Step 302]. Then, at least one vertical frame member 120 may be connected by attaching at least one horizontal frame member 130 to each vertical frame member 120 of the frame 110 [Step 304]. Then, the frame 110 may be secured to a wall surface 10 via at least one fastener 170 [Step 306]. Next, at least one pot 150 may be fixedly or removably attached to the vertical frame members 120 or the horizontal frame members 130 of the frame 110 via at least one fastener 132, 142, 152 [Step 308]. Then, the user may plant any type of plant into each pot 150 that is attached to the vertical frame member 120 or horizontal frame member 130 [Step 310].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “portable gardening structure device” and “device” are interchangeable and refer to the portable gardening structure device 100 of the present invention.

Notwithstanding the foregoing, the portable gardening structure device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the portable gardening structure device 100 as shown in the FIGS. are for illustrative purposes only, and that many other sizes and shapes of the portable gardening structure device 100 are well within the scope of the present disclosure. Although the dimensions of the portable gardening structure device 100 are important design parameters for user convenience, the portable gardening structure device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A portable gardening structure device comprising:
a vertical frame member;
a fastener; and
a pot that attaches to the vertical frame member via the fastener.

2. The portable gardening structure device of claim 1, wherein the vertical frame member is comprised of a pointed end.

3. The portable gardening structure device of claim 1, wherein the fastener is comprised of a screw, a nail, an adhesive, a glue, a hook-and-loop fastener, a tongue-and-groove fastener, a magnet, or a tie wrap.

4. A portable gardening structure device comprising:
a vertical frame member;
a horizontal frame member that attaches to the vertical frame member via a first fastener;
a pot; and
a second fastener.

5. The portable gardening structure device of claim 4, wherein the first fastener is comprised of a magnet, a glue, a tongue, a groove, a hook fastener, a loop fastener, a screw, or a bolt.

6. The portable gardening structure device of claim 4, wherein the pot attaches to the horizontal frame member via the second fastener.

7. The portable gardening structure device of claim 6, wherein the second fastener is comprised of a magnet, a glue, a tongue, a groove, a hook fastener, a loop fastener, a screw, or a bolt.

8. The portable gardening structure device of claim 4, wherein the pot attaches to the vertical frame member via the second fastener.

9. The portable gardening structure device of claim 8, wherein the fastener is comprised of a magnet, a glue, a tongue, a groove, a hook fastener, a loop fastener, a screw, or a bolt.

10. The portable gardening structure device of claim 4, wherein the vertical frame member is comprised of a decorative element.

11. The portable gardening structure device of claim 10, wherein the decorative element is comprised of a protective coating.

12. A method of using a portable gardening structure device, the method comprising the following steps:
providing a portable gardening structure device comprised of a frame and a pot attached to the frame;
securing the frame into a ground surface or to a wall surface; and
planting a plant in the pot.

13. The method of using a portable gardening structure device of claim 12, wherein the frame is comprised of a horizontal frame member and a vertical frame member.

14. The method of using a portable gardening structure device of claim 13 further comprised of a step of attaching a vertical member of the frame to a horizontal member of the frame.

15. The method of using a portable gardening structure device of claim 14, wherein the vertical member is attached to the horizontal member via a first fastener.

16. The method of using a portable gardening structure device of claim 14 further comprised of a step of attaching the pot to the vertical member.

17. The method of using a portable gardening structure device of claim 16, wherein the pot is attached to the vertical member via a second fastener.

18. The method of using a portable gardening structure device of claim 14 further comprised of a step of attaching the pot to the horizontal member.

19. The method of using a portable gardening structure device of claim 18, wherein the pot is attached to the horizontal member via a third fastener.

20. The method of using a portable gardening structure device of claim 12, wherein the frame is comprised of a wood material.
